(19) United States
(12) Patent Application Publication
(10) Pub. No.: US 2004/0250048 A1
(43) Pub. Date: Dec. 9, 2004

(54) Information processing device and machine language program converter

(75) Inventors: Koji Nakajima, Kyoto (JP); Kensuke Odani, Kyoto (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/843,434

(22) Filed: May 12, 2004

(30) Foreign Application Priority Data
Jun. 3, 2003 (JP) 2003-157487

(51) Int. Cl. G06F 15/00

(52) U.S. Cl. 712/22

(57) ABSTRACT

The information processing device having a SIMD operator includes: a SIMD processing division means for receiving a SIMD instruction from a machine language program and outputting the SIMD instruction repeatedly by a predetermined number of times; a memory address conversion means for converting the memory address of a SIMD instruction related to memory access output from the SIMD processing division means according to the number of times of repetition of the SIMD instruction and outputting the results to the SIMD operator; and a register switch means having a group of registers for the SIMD operator for switching the group of registers to be used by the SIMD operator according to the number of times of repetition of the SIMD instruction.

### BACKGROUND OF THE INVENTION

The present invention relates to a technology related to processing of machine language programs including SIMD (single instruction stream/multiple data stream) instructions. More particularly, the present invention relates to a technology that makes a machine language program executable even when the parallel degree of the machine language program does not agree with the number of processors in an information processing device, and a technology of producing a new machine language program having a parallel degree changed from the original program.

In media processing such as image processing, same computation is often necessary for a plurality of pieces of data. In this relation, by configuring hardware to perform same computation for a plurality of pieces of data, high-speed media processing is attained. This hardware architecture is called “SIMD architecture”. Examples of such SIMD architecture are vector computers often used for large-scale computers, SIMD multi-processors in which a plurality of processors are controlled under same instructions, and SIMD instructions in which a plurality of pieces of data are processed under one instruction from a single processor.

The characteristics required for processors for media processing vary with the use of the processors. For example, when high-speed processing is necessary, the data amount processable at one time must be large. In reverse, when the data handled is not so large and high priority is placed on reduction in power consumption by scaling down the hardware, the data amount processable at one time may be made small. The data amount processable at one time is herein called the “parallel degree”. Processors for media processing are allowed to have their balance between the performance and the hardware amount by increasing/decreasing the parallel degree.

The computation in media processing includes many unique operations. Therefore, processors for media processing are often provided with exclusive instructions for processing such unique operations at high speed. However, when a high-level language is used in programming of media processing, such unique operations may not be used effectively, and thus the processors may fail to make full use of their performance. In description of a program including many such unique operations, therefore, a machine language program is often used to describe the computation, to place high importance on the performance.

In machine language programming of the SIMD architecture, various problems arise when the parallel degree is changed. For example, in a SIMD multi-processor, each instruction involves parallel processing of the degree proportional to the number of processors. If the parallel degree, that is, the number of processors changes, the operation of the parallel processing will become different from the original. In particular, in the case of an instruction related to memory access, data in a wrong memory address will be accessed unless the address offset is appropriately changed according to the change of the number of processors.

To overcome the above problem, it is conventionally necessary to change the machine language program accordingly when the parallel degree of the SIMD architecture is changed. To attain this, conventionally, a new machine language program is produced by converting (vectorizing) sequential programming in a high-level language to SIMD processing.

The above technique supports sequential programming described in a high-level language, but does not support machine language programming of a SIMD architecture used for media processing and the like. Therefore, conventionally, when the parallel degree is changed in machine language programming of a SIMD architecture, the description of the machine language program must be changed manually in many cases.

Machine language programs having various parallel degrees may be prepared in advance to meet SIMD architectures having various parallel degrees. This will eliminates the necessity of changing the description of the machine language program every time the parallel degree is changed. In this case, however, in a type of hardware permitting dynamic change of the parallel degree, for example, it is necessary to hold a plurality of machine language programs corresponding to a plurality of parallel degrees. This necessitates a larger amount of memory space and thus will be against the trend of reduction in the size and cost of the equipment.

### SUMMARY OF THE INVENTION

An object of the present invention is providing an information processing device for performing SIMD computation according to a machine language program including a SIMD instruction, in which the machine language program can be executed even when the parallel degree of the machine language program does not agree with the parallel degree of the SIMD architecture of the information processing device. Another object of the present invention is providing a program converter for changing the parallel degree of an original machine language program to produce a new machine language program.

The information processing device of the present invention, which has a SIMD operator and performs SIMD computation according to a machine language program including a SIMD instruction, includes SIMD processing division means for receiving a SIMD instruction or a plurality of continuous SIMD instructions from the machine language program and outputting the SIMD instruction or the plurality of continuous SIMD instructions repeatedly by a number of times corresponding to a number into which the processing is divided, wherein the SIMD instruction output from the SIMD processing division means is executed with the SIMD operator.

According to the invention described above, the SIMD processing division means receives a SIMD instruction or a plurality of continuous SIMD instructions from a machine language program, and outputs the SIMD instruction or the plurality of continuous SIMD instructions repeatedly by the number of times corresponding to the number into which the processing is divided. The repeatedly output SIMD instructions are executed with the SIMD operator. In this way, by executing a same SIMD instruction a plurality of times, a SIMD instruction having a high parallel degree is executed with a SIMD operator having a low parallel degree in a plurality of execution clocks. In other words, the information processing device of the present invention executes an input machine language program even when the parallel degree of the program does not agree with the parallel degree of the SIMD operator.

Preferably, the information processing device described above further includes memory address conversion means for converting an original memory address of a SIMD instruction related to memory access among SIMD instructions output from the SIMD processing division means to a new memory address according to the ordinal number of the repetition of output of the SIMD instruction.

According to the invention described above, the memory address conversion means converts the original memory address of a SIMD instruction output repeatedly from the SIMD processing division means to a new memory address corresponding to the ordinal number of the repetition of output of the SIMD instruction. By converting the original memory address to a new memory address in this way, access to a correct memory address is attained during the divided execution of the SIMD instruction.

Preferably, the information processing device described above further includes register switch means having a group of registers for the SIMD operator, of a number corresponding to the number into which the processing is divided. The register switch means switches the group of registers to be used by the SIMD operator according to the ordinal number of the repetition of output of the SIMD instruction by the SIMD processing division means.

According to the invention described above, the resister switch means switches the group of registers to be used by the SIMD operator according to the ordinal number of the repetition of output of the SIMD instruction. This prevents the executed results of the other SIMD instructions from being overwritten.

Preferably, the information processing device described above further includes SIMD processing dividing number calculation means for calculating the number into which the processing is divided based on information on the parallel degree of the SIMD operator and information on the parallel degree of the machine language program indicated in the machine language program.

The machine language program converter of the present invention includes: SIMD processing division means for receiving an original machine language program including a SIMD instruction and producing an intermediate machine language program composed of repetition of the entire instruction string included in the original machine language program by a number of times corresponding to a number into which the processing is divided; and memory address conversion means for converting an original memory address of a SIMD instruction related to memory access among SIMD instructions included in the intermediate machine language program produced by the SIMD processing division means to a new memory address, wherein the intermediate machine language program subjected to the memory address conversion by the memory address conversion means is output as a new machine language program.

According to the invention described above, the SIMD processing division means produces the intermediate machine language program including the entire instruction string in the original machine language program repeated by the number of times corresponding to the number into which the processing is divided. The memory address conversion means converts the original memory address of a SIMD instruction related to memory access in the intermediate machine language program to a new memory address, and outputs the results as a new machine language program. In this way, by executing the original machine language program a plurality of times, a SIMD instruction having a high lo parallel degree is executed with a SIMD operator having a low parallel degree in a plurality of execution clocks. As for a SIMD instruction related to memory access, by converting the original memory address thereof to a new memory address, access to a correct memory address is attained during the divided execution of the SIMD instruction.

In this way, the machine language program converter of the present invention automatically produces a new machine language program by changing the parallel degree of the original machine language program.

Specifically, the intermediate machine language program is preferably composed of an instruction string in which the entire instruction string included in the original machine language program is repeated by a number of times corresponding to the number into which the processing is divided, and the memory address conversion means preferably converts an original memory address of a SIMD instruction related to memory access included in the intermediate machine language program to a new memory address according to the ordinal number of the repetition of output of the SIMD instruction.

Specifically, the intermediate machine language program is preferably composed of a loop instruction string in which the entire instruction string included in the original machine language program is given as a subroutine and the subroutine is called by a number of times corresponding to the number into which the processing is divided, and the memory address conversion means preferably rewrites an address offset of the original memory address into a variable indicating the ordinal number of looping in the execution of the loop instruction string.

### BRIEF DESCRIPTION OF THE DRAWINGS

FIG. 1 is a block diagram of an information processing device of Embodiment 1 of the present invention.

FIGS. 2A and 2B are views showing examples of configuration of a SIMD operator.

FIG. 3 is a view showing an example of a machine language program.

FIG. 4 is a view illustrating the operation of a SIMD processing division means in FIG. 1.

FIG. 5 is a view illustrating the operation of a memory address conversion means in FIG. 1.

FIG. 6 is a view showing a first example of memory address conversion.

FIG. 7 is a view showing a second example of memory address conversion.

FIG. 8 is a block diagram of information processing devices of Embodiments 2 and 3 of the present invention.

FIG. 9 is a view illustrating the operation of a SIMD processing division means in Embodiment 2.

FIG. 10 is a view illustrating the operation of a memory address conversion means in Embodiment 2.

FIG. 11 is a view illustrating the operation of a SIMD processing division means in Embodiment 3.

FIG. 12 is a view illustrating the operation of a memory address conversion means in Embodiment 3.

### DESCRIPTION OF THE PREFERRED EMBODIMENTS

Hereinafter, preferred embodiments of the present invention will be described with reference to the accompanying drawings.

### Embodiment 1

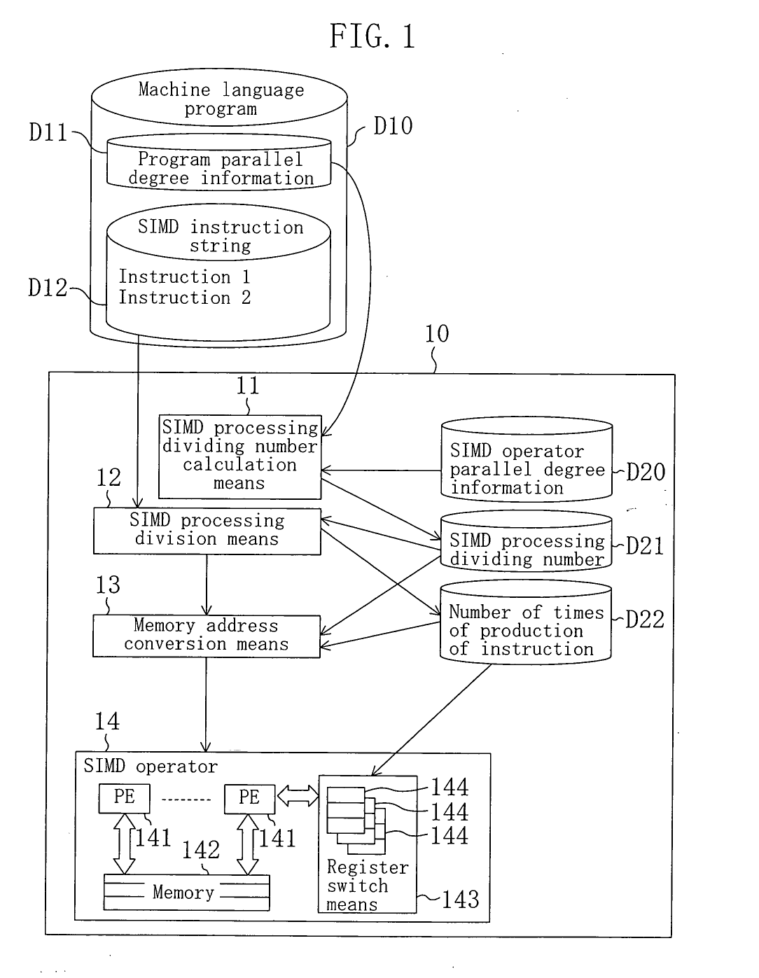

FIG. 1 shows a configuration of an information processing device of Embodiment 1 of the present invention. The information processing device of this embodiment, denoted by the reference numeral 10, which executes a machine language program D10, includes a SIMD processing dividing number calculation means 11 (hereinafter, also simply called a “calculation means 11”), a SIMD processing division means 12 (hereinafter, also simply called a “division means 12”), a memory address conversion means 13 (hereinafter also simply called a “conversion means 13”), and a SIMD operator 14. The information processing device 10 is used as an MPEG (Moving Picture Experts Group) codec, for example. Each of the calculation means 11, the division means 12 and the conversion means 13 can be implemented by hardware or by program processing.

The machine language program D10 to be input into the information processing device 10 includes: program parallel degree information D11 (hereinafter, simply called “information D11”) representing the parallel degree of the SIMD processing in the machine language program D10; and a SIMD instruction string D12 including at least one SIMD instruction to be executed by the SIMD operator 14. The programmer can designate the information D11 as appropriate. That is, it is allowed to use same instruction/operation description irrespective of the parallel degree of the SIMD operator. The information D11 can be designated by using an exclusive instruction to be described later or storing the information D11 in a designated register or memory address, for example.

Hereinafter, each of the components of the information processing device 10 will be summarized.

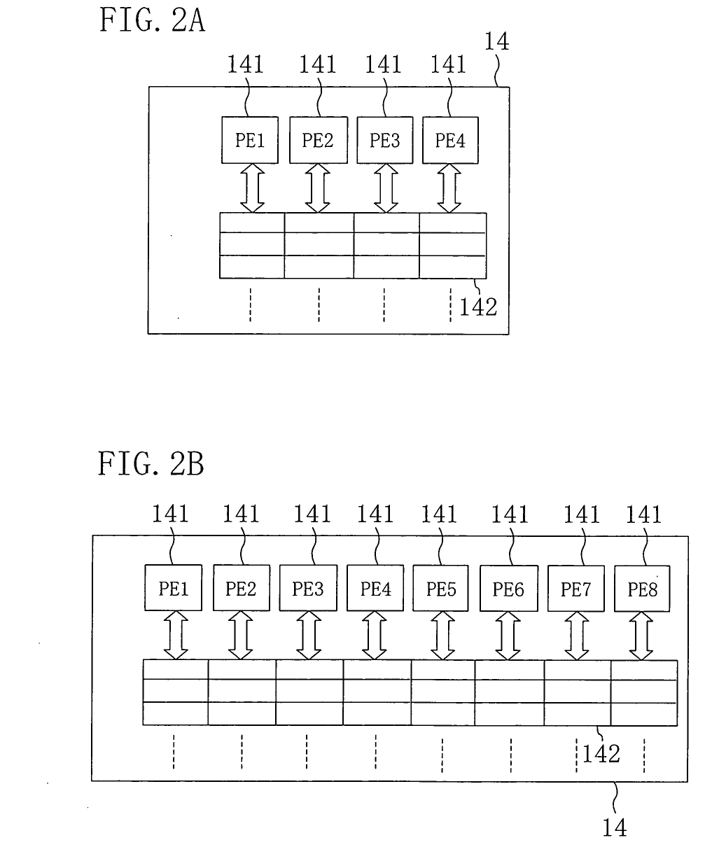

The SIMD processing dividing number calculation means 11 calculates a SIMD processing dividing number D21 (hereinafter, simply called a “dividing number D21”) into which the SIMD processing is divided for execution, from the information D11 in the machine language program D10 and SIMD operator parallel degree information D20 (hereinafter, simply called “information D20”) that represents the parallel degree of the 10 SIMD operator 14. The parallel degree of the SIMD operator 14 represented by the information D20 specifically indicates the number of processor elements 141 in the SIMD operator 14. For example, in an example of the SIMD operator 14 shown in FIG. 2A, a total of four processor elements 141 are independently accessible to a data memory 142. In another example shown in FIG. 2B, a total of eight processor elements 141 are independently accessible to a data memory 142. In these examples in FIGS. 2A and 2B, therefore, the parallel degree of the SIMD operator 14 is “4” and “8, respectively. The information D20 may be acquired by using an exclusive instruction or by retrieving from a predetermined register or memory address, for example.

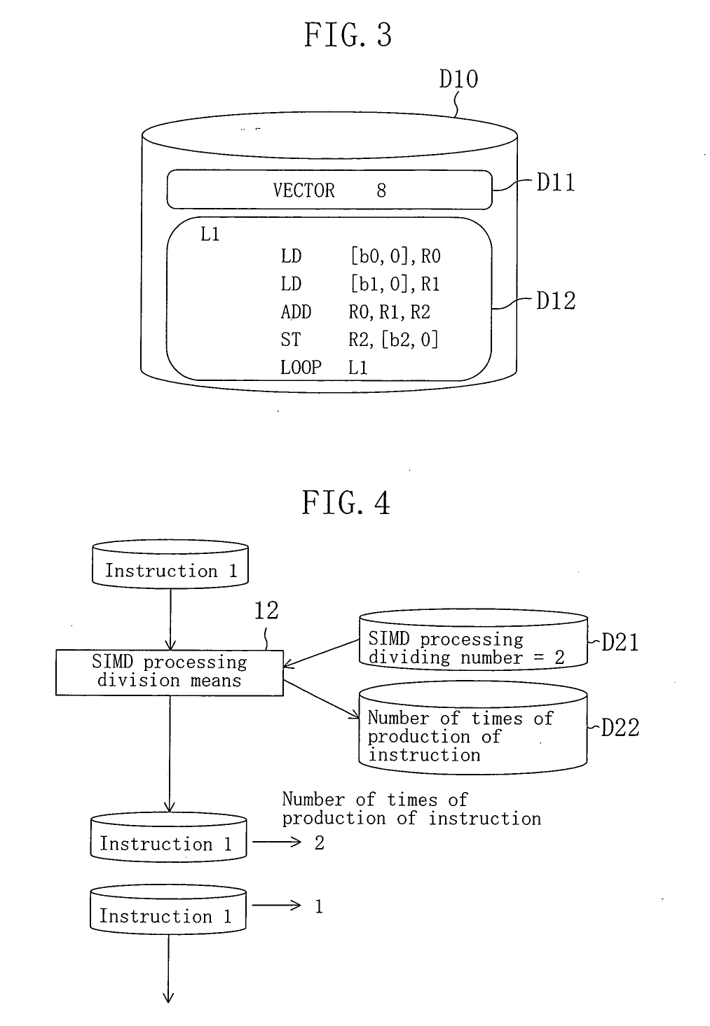

The information D11 is described as a specific value in the machine language program D10. For example, in an example of the machine language program D10 shown in FIG. 3, the information D11 is described in VECTOR instruction at the head of the program. The VECTOR instruction, located at the head of the machine language program D10, is an exclusive instruction for specifying the parallel degree of the program for the information processing device 10. In the illustrate example, “8” is designated as the information D11.

The dividing number D21 can be calculated by dividing the value of the information D11 by the value of the information D20. Specifically, when the machine language program D10 is to be processed with the SIMD operator 14 of FIG. 2A, the dividing number D21 is “2” (8/4=2). The dividing number D21, which does not change throughout the execution of the machine language program D10, may only be calculated once at the start of the execution of the program. Normally, the architecture of the SIMD operator 14 is designed to give an integer as the result of the above division. The present invention is also applicable to the case that the division result is not an integer. For example, when an 8-parallel machine language program is to be executed with a 5-parallel SIMD operator, either one of processor elements of the SIMD operator may be put to sleep to give a 4-parallel operator. However, since this way of use degrades the processing efficiency, this architecture is not adopted normally. Hereinafter, therefore, only the case that the division result is an integer will be described.

Referring back to FIG. 1, the SIMD processing division means 12 receives each of SIMD instructions included in the SIMD instruction string D12, and outputs the SIMD instruction repeatedly by the number of times indicated by the dividing number D21 calculated by the calculation means 11. The ordinal number of this repetition of the output is counted as the number of times of production of the instruction D22 (hereinafter, simply called the “number of times D22”). A specific example of the operation of SIMD processing division means 12 is shown in FIG. 4. In FIG. 4, when the SIMD processing division means 12 receives a SIMD instruction (“Instruction 1” in FIG. 4), it outputs the SIMD instruction (Instruction 1) twice repeatedly as indicated by the dividing number D31. The number of times D22 is “1” at the first output of the SIMD instruction (Instruction 1) and “2” at the second output thereof.

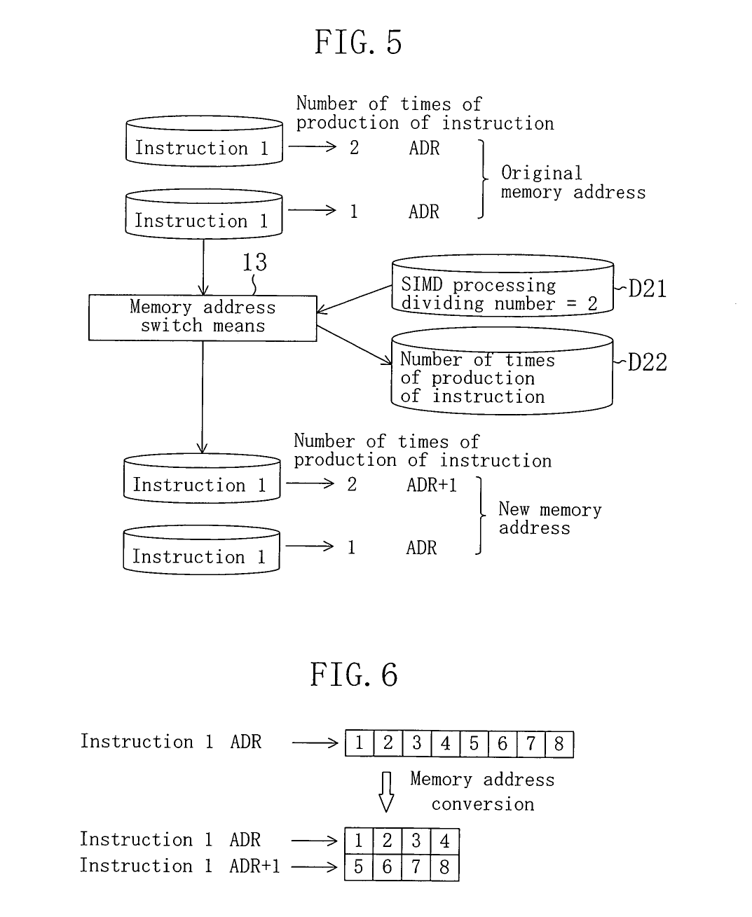

As shown in FIG. 5, the memory address conversion means 13 converts the original memory addresses of the SIMD instructions (related to memory access) output from the division means 12 to respective new memory addresses as the actual destinations of reference of the data, and outputs the results sequentially to the SIMD operator 14. This memory address conversion will be specifically described later.

Referring again to FIG. 1, the SIMD operator 14, which executes the SIMD instructions output from the conversion means 13, includes a plurality of processor elements 141, a data memory 142 to which the processor elements 141 are individually accessible, and a register switch means 143. The register switch means 143 has a plurality of registers 144 for the SIMD operator 14, and switches the group of registers 144 according to the number of times D22, so that the SIMD operator 14 performs SIMD computation using the switched registers 144. By appropriately switching the group of registers 144 used by the SIMD operator 14 during execution of the SIMD instructions as described above, the trouble of the registers 144 being overwritten due to the division of the SIMD processing is prevented. It is assumed that the number of registers 144 of the register switch means 143 is at least larger than the dividing number D21.

Hereinafter, a specific method of the memory address conversion by the memory address conversion means 13 will be described, taking as an example the case that the SIMD operator 14 having a parallel degree of “4” executes a SIMD instruction having a parallel degree of “8”.

FIG. 6 shows a first example of the memory address conversion. In this example, assume that the data memory 142 of the SIMD operator 14 can store four parallel data units for each unit address. The SIMD instruction (“Instruction 1” in FIG. 6) in the machine language program D10 instructs to perform SIMD processing for 8-parallel data (shown with the numbers “1” to “8” in FIG. 6) designated by an original memory address “ADR”. The 8-parallel data designated by the original memory address “ADR” is stored at two continuous memory addresses in the data memory 142 of the SIMD operator 14 as two pieces of 4-parallel data. To ensure correct reference to the data stored dividedly, the memory address of one of two SIMD instructions produced by the SIMD processing division means 12 is converted from “ADR” to “ADR+1”.

In the illustrated example, a new memory address ADRnew can be obtained by

ADRnew=ADRorg+n−1

where ADRorg is the original memory address and n is the number of times D22. The new memory address ADRnew may also be obtained by

ADRnew=ADRorg+DIV−n

where DIV is the dividing number D21.

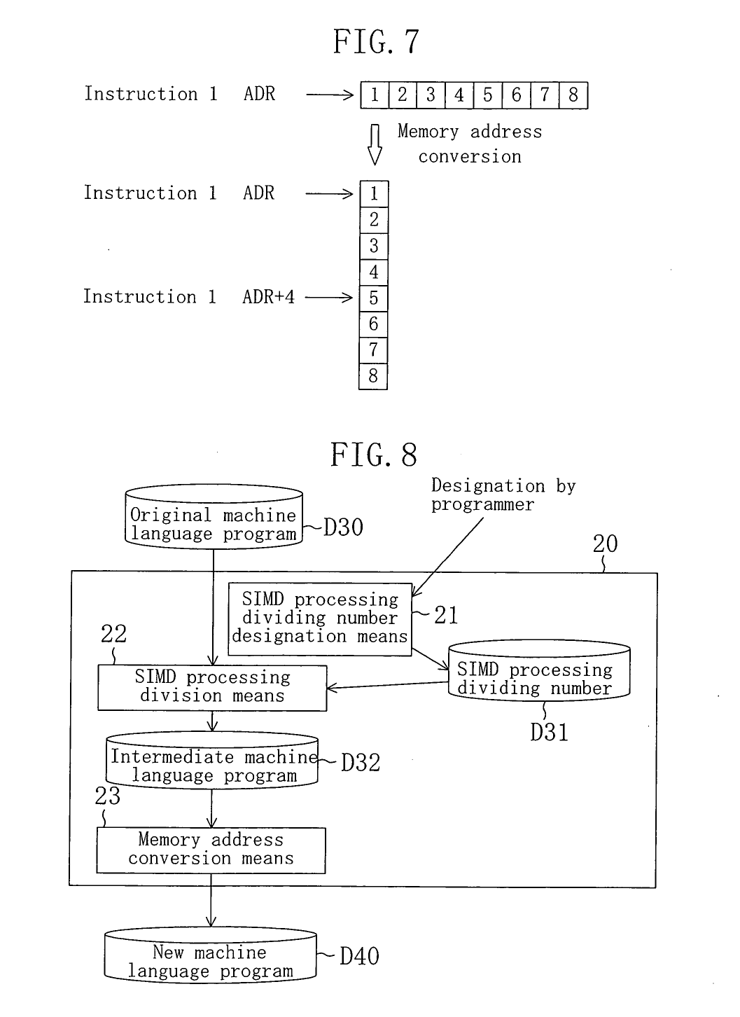

FIG. 7 shows a second example of the memory address conversion. In this example, assume that the data memory 142 of the SIMD operator 14 stores one data unit for each unit address. The SIMD instruction (“Instruction 1” in FIG. 7) in the machine language program D10 instructs to perform SIMD processing for 8-parallel data (shown with the numbers “1” to “8” in FIG. 7) designated by the original memory address “ADR”. The 8-parallel data designated by the original memory address “ADR” is stored at eight continuous memory addresses in the data memory 142 of the SIMD operator 14. To ensure correct reference to the data stored dividedly, the memory address of one of two SIMD instructions produced by the SIMD processing division means 12 is converted from “ADR” to “ADR+4”.

In the illustrated example, a new memory address ADRnew can be obtained by

ADRnew=ADRorg+(n−1)*SPNUM

where ADRorg is the original memory address, n is the number of times D22, and SPNUM is the parallel degree of the data memory 142. The new memory address ADRnew may also be obtained by

ADRnew=ADRorg+(DIV−n)*SPNUM

where DIV is the dividing number D21. Note that the parallel degree SPNUM of the data memory 142 as used herein refers to the value obtained by dividing the number of effectively operating processor elements 141 of the SIMD operator 14 by the number of data units storable for each unit address in the data memory 142.

In association with the memory address conversion by the memory address conversion means 13, an address offset is rewritten specifically in the following manner. In a SIMD instruction, the memory address is described as “[A, B]” where A is a program memory address described by the programmer generally in the form of “register+constant”, and B is an address offset in which constant “0” is normally written by the programmer. Alternatively, the programmer may describe no explicit value for B. According to the specifications described above, the description of a memory access instruction will be something like “LD [b0+1, 0], R0”, for example. The memory address conversion means 13 rewrites the portion of this description corresponding to B as required. In the second example described above, the description of the memory access instruction after the memory address conversion will be something like “LD [b0+1, 4], R0”.

As described above, according to this embodiment, the machine language program D10 having any parallel degree is virtually executed by the SIMD operator 14 having a given parallel degree. This eliminates the necessity of rewriting the machine language program D10. Also, in an information processing device permitting dynamic change of the parallel degree, in which a half of its processor elements will be put to sleep in operation in a power save mode, for example, it is no more necessary to store a plurality of machine language programs corresponding to all changeable parallel degrees.

Note that in FIG. 4, the SIMD processing division means 12 is shown to receive the SIMD instructions one by one. The present invention is not limited to this, but the division means 12 may receive the string of the plurality of continuous SIMD instructions and outputs the instruction string repeatedly by a predetermined number of times.

The SIMD processing dividing number calculation means 11 may be omitted by giving a constant as the dividing number D21. In this case, if constant “2”, for example, is given as the dividing number D21, the information processing device 10 will execute the received machine language program D10 by invariably halving the original parallel degree.

In the case that there is no SIMD instruction related to memory access in the machine language program D10, in which no memory address conversion is necessary, the conversion means 13 may be omitted.

A means other than the register switch means 143 may be adopted to prevent the registers from being overwritten. In such a case, also, the effect of the present invention described above can be obtained.

### Embodiment 2

FIG. 8 shows a configuration of a machine language program converter of Embodiment 2 of the present invention. The machine language program converter of this embodiment, denoted by the reference numeral 20, includes a SIMD processing dividing number designation means 21 (hereinafter, also simply called a “designation means 21”), a SIMD processing division means 22 (hereinafter, also simply called a “division means 22”), and a memory address conversion means 23 (hereinafter also simply called a “conversion means 23”). The machine language program converter 20 receives an original machine language program D30 including a SIMD instruction, lowers the parallel degree of the original machine language program D30, and outputs the results as a new machine language program D40. Each of the designation means 21, the division means 22 and the conversion means 23 can be implemented by hardware or by program processing.

Hereinafter, each of the components of the machine language program converter 20 will be summarized.

The SIMD processing dividing number designation means 21 acquires the number into which the SIMD processing is divided, designated by the programmer, and sets the number as a SIMD processing dividing number D31 (hereinafter, simply called a “dividing number D31”). The designation of the dividing number can be made by designating a constant as an option at the start of the machine language program converter 20, for example.

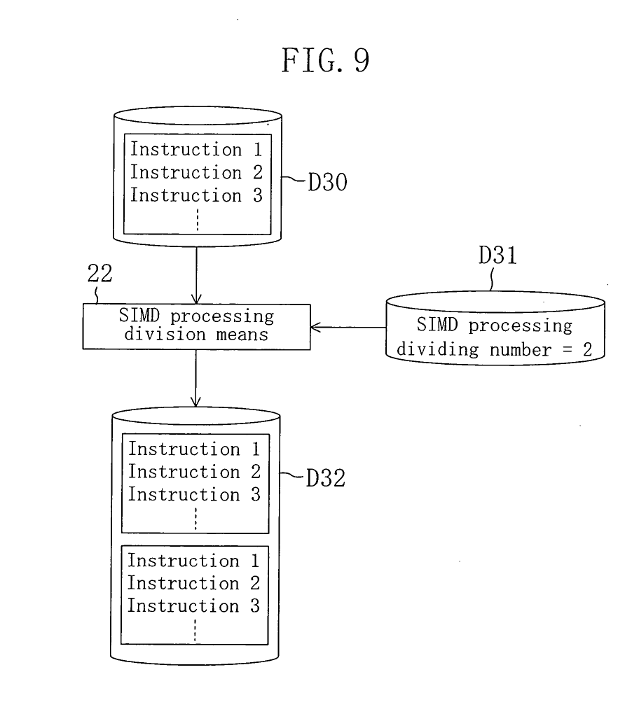

The SIMD processing division means 22 outputs the entire instruction string included in the original machine language program D30 repeatedly by the number of times indicated by the dividing number D31 as an intermediate machine language program D32: FIG. 9 shows a specific example of the operation of the SIMD processing division means 22. In the illustrate example, the entire instruction string in the original machine language program D30 is output twice repeatedly as indicated by the dividing number D31.

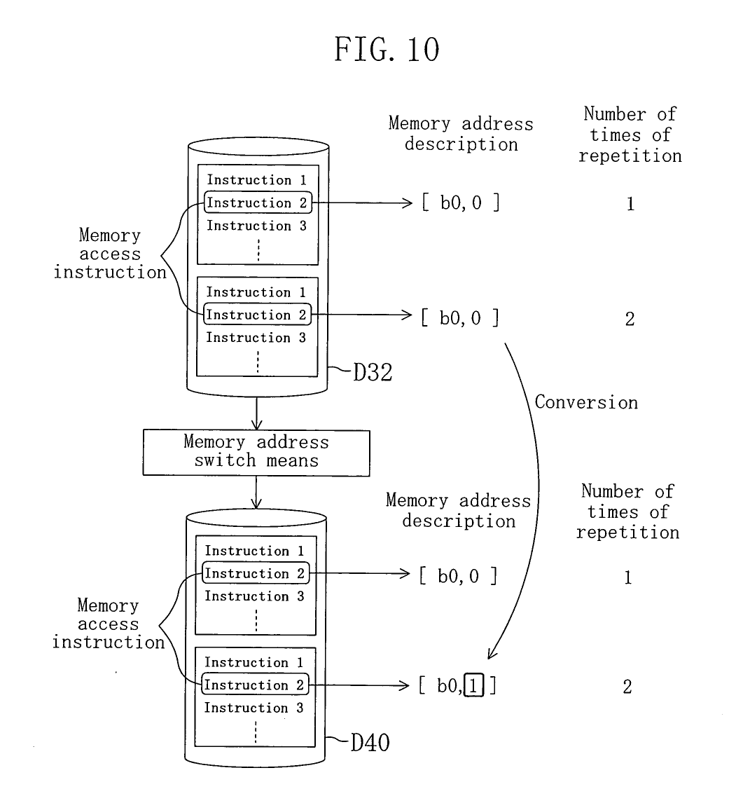

Referring back to FIG. 8, the memory address conversion means 23 converts the original memory address of a SIMD instruction related to memory access among the SIMD instructions included in the intermediate machine language program D32 to a new memory address according to the ordinal number of the repetition of output of the SIMD instruction, and outputs the resultant new machine language program D40. FIG. 10 shows a specific example of the operation of the memory address conversion means 23. In the illustrated example, the address offset of a memory access instruction (“Instruction 2” in FIG. 10) included in the intermediate machine language program D32 is rewritten according to the ordinal number of the repetition of output of the memory access instruction (number of times of repetition). The conversion from the original memory address to the new memory address can be performed in the manner described in Embodiment 1.

The thus-produced new machine language program D40 can be executed with a general SIMD operator. In other words, the SIMD operator for executing the new machine language program D40 is not especially required to have the register switch means possessed by the SIMD operator in Embodiment 1.

As described above, according to this embodiment, the new machine language program D40 is automatically produced by converting the parallel degree of the original machine language program D30. The new machine language program D40 is a program obtained by continuously describing the entire instruction string included in the original machine language program D30 by a predetermined number of times. Therefore, in some type of the SIMD operator for executing the new machine language program D40, a plurality of instructions can be processed in parallel at the connection point of these continuous instructions. This enables execution of the new machine language program D40 in a shorter time than the time required to simply execute the original machine language program D30 repeatedly by a predetermined number of times.

The SIMD processing division means 22 may be configured to output part of the instruction string, not the entire instruction string, included in the original machine language program D30 as a unit repeatedly. In this case, however, the SIMD operator for executing the produced new machine language program D40 is required to have a register switch means as that described in Embodiment 1, and the SIMD processing division means 22 is required to output an instruction for controlling the switching of registers.

### Embodiment 3

The machine language program converter of Embodiment 3 of the present invention is the same in configuration as the machine language program converter 20 of Embodiment 2 shown in FIG. 8, but is different in the operation of the SIMD processing division means 22 and the memory address conversion means 23 from those in Embodiment 2. Hereinafter, the operation of the SIMD processing division means 22 and the memory address conversion means 23 of the machine language program converter 20 of this embodiment will be described.

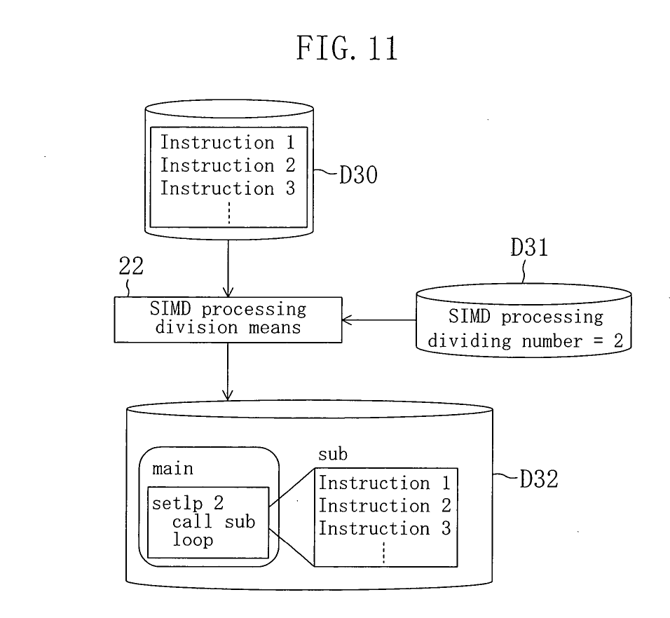

The SIMD processing division means 22 gives the entire instruction string included in the original machine language program D30 as a subroutine, produces a loop instruction string in which the subroutine is repeated by the number of times indicated by the dividing number D31, and outputs the loop instruction string as the intermediate machine language program D32. FIG. 11 shows a specific example of the operation of the SIMD processing division means 22. In the illustrated example, the entire instruction string in the original machine language program D30 is given as a subroutine sub, and a function main that calls the subroutine sub twice as indicated by the dividing number D31 is produced as the intermediate machine language program D32.

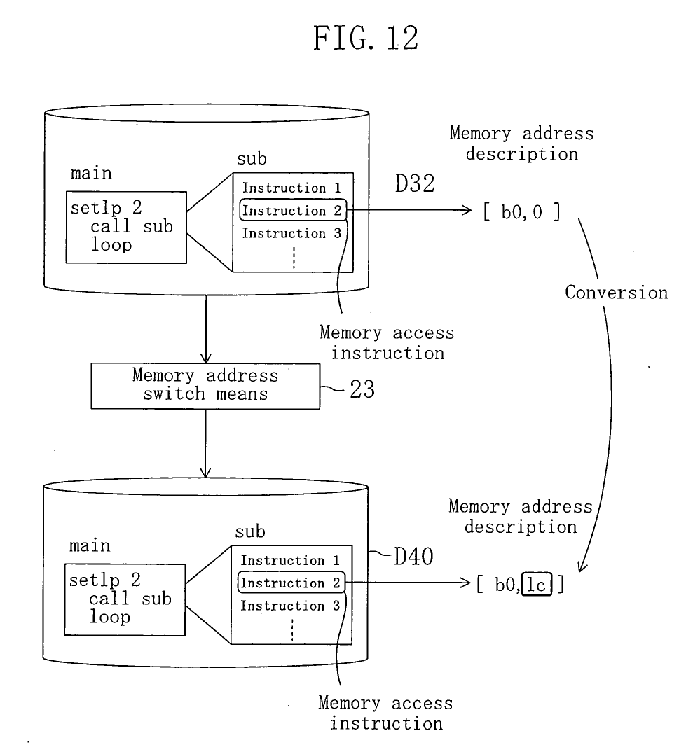

The memory address conversion means 23 rewrites the address offset of a SIMD instruction related to memory access among SIMD instructions included in the intermediate machine language program D32 into a variable indicating the ordinal number of the looping in the execution of the loop instruction string, and outputs the resultant new machine language program D40. FIG. 12 shows a specific example of the operation of the memory address conversion means 23. In the illustrated example, the address offset of a memory access instruction (“Instruction 2” in FIG. 12) included in the intermediate machine language program D32 is rewritten into the number of an exclusive register 1c that stores a loop counter. In this example, the address offset is rewritten with the assumption that a SIMD operator for executing the new machine language program D40 has the exclusive register 1c. Alternatively, the description may be made to use a general register in place of the exclusive register 1c.

As described above, according to this embodiment, the new machine language program D40 smaller in size than that in Embodiment 2 is produced. The user is therefore free to select the new machine language program D40 in this embodiment when importance is placed on the program size or the new machine language program D40 in Embodiment 2 when importance is placed on the processing performance.

The SIMD processing division means 22 may be configured to give part of the instruction string, not the entire instruction string, included in the original machine language program D30 as a subroutine. In this case, however, as described above, a SIMD operator for executing the produced new machine language program D40 is required to have a register switch means, and the SIMD processing division means 22 is required to output an instruction for controlling the switching of registers.

The machine language program converter 20 of Embodiments 2 and 3 may be combined with a SIMD operator for executing the new machine language program D40 produced by the machine language program converter 20, to provide an information processing device like that of Embodiment 1. The information processing device in this case will convert the entire machine language program as the input and execute the converted machine language program, unlike that of Embodiment 1.

As described above, according to the present invention, provided is the SIMD processing division means that converts an input machine language program including SIMD instructions to a program composed of repetition of the SIMD instructions by the number of times corresponding to the processing dividing number. By having this means, a machine language program adapted to a certain SIMD operator having a given parallel degree is also executed with another SIMD operator scaled down in parallel degree only, without the necessity of changing the description of the machine language program. Also, provided is the memory access conversion means that converts the original memory address of a SIMD instruction related to memory access among the SIMD instructions to a new memory address according to the ordinal number of the repetition. By having this means, when the machine language program is executed with a SIMD operator scaled down in parallel degree only, correct memory access according to the memory configuration of the SIMD operator is allowed for the SIMD instruction.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. An information processing device having a SIMD operator for executing SIMD computation according to a machine language program including a SIMD instruction, the device comprising:
SIMD processing division means for receiving a SIMD instruction or a plurality of continuous SIMD instructions from the machine language program and outputting the SIMD instruction or the plurality of continuous SIMD instructions repeatedly by a number of times corresponding to a number into which the processing is divided,
Wherein the SIMD instruction output from the SIMD processing division means is executed with the SIMD operator.

2. The information processing device of claim 1, further comprising:
memory address conversion means for converting an original memory address of a SIMD instruction related to memory access among SIMD instructions output from the SIMD processing division means to a new memory address according to the ordinal number of the repetition of output of the SIMD instruction.

3. The information processing device of claim 1, further comprising:
register switch means having a group of registers for the SIMD operator, of a number corresponding to the number into which the processing is divided, the register switch means switching the group of registers to be used by the SIMD operator according to the ordinal number of the repetition of output of the SIMD instruction by the SIMD processing division means.

4. The information processing device of claim 1, further comprising:
SIMD processing dividing number calculation means for calculating the number into which the processing is divided based on information on the parallel degree of the SIMD operator and information on the parallel degree of the machine language program indicated in the machine language program.

5. A machine language program converter comprising:
SIMD processing division means for receiving an original machine language program including a SIMD instruction and producing an intermediate machine language program composed of repetition of the entire instruction string included in the original machine language program by a number of times corresponding to a number into which the processing is divided; and
memory address conversion means for converting an original memory address of a SIMD instruction related to memory access among SIMD instructions included in the intermediate machine language program produced by the SIMD processing division means to a new memory address,
wherein the intermediate machine language program subjected to the memory address conversion by the memory address conversion means is output as a new machine language program.

6. The machine language program converter of claim 5, wherein the intermediate machine language program is composed of an instruction string in which the entire instruction string included in the original machine language program is repeated by a number of times corresponding to the number into which the processing is divided, and
the memory address conversion means converts an original memory address of a SIMD instruction related to memory access included in the intermediate machine language program to a new memory address according to the ordinal number of the repetition of output of the SIMD instruction.

7. The machine language program converter of claim 5, wherein the intermediate machine language program is composed of a loop instruction string in which the entire instruction string included in the original machine language program is given as a subroutine and the subroutine is called by a number of times corresponding to the number into which the processing is divided, and
the memory address conversion means rewrites an address offset of the original memory address into a variable indicating the ordinal number of looping in the execution of the loop instruction string.
